(19) United States
(12) Patent Application Publication
(10) Pub. No.: US 2017/0168792 A1
(43) Pub. Date: Jun. 15, 2017

(54) SPACE AND TIME AWARE ORGANIZATION AND ISOLATION OF COMPONENTS IN REAL TIME SYSTEMS

(71) Applicant: Futurewei Technologies, Inc., Plano, TX (US)

(72) Inventors: Debashis Bhattacharya, Plano, TX (US); Alan Gatherer, Richardson, TX (US); Mark Brown, Little Elm, TX (US); Lee Dobson McFearin, Plano, TX (US); Alex Elisa Chandra, Plano, TX (US); Ashish Rai Shrivastava, Plano, TX (US)

(21) Appl. No.: 15/378,714

(22) Filed: Dec. 14, 2016

Related U.S. Application Data
(60) Provisional application No. 62/267,473, filed on Dec. 15, 2015.

(51) Int. Cl. G06F 9/45

(52) U.S. Cl. CPC G06F 8/51

(57) ABSTRACT

A method includes obtaining, by a first processor, a first software architecture description file and obtaining, by the first processor, a platform independent model file. The method also includes obtaining, by the first processor, a platform architecture definition file and performing, by the first processor, a first source-to-source compilation in accordance with the first software architecture description file, the platform independent model file, and the platform architecture definition file, to produce generated interface code. Additionally, the method includes generating, by the first processor, run time code, in accordance with the generated interface code and running, by a second processor in real time, the run time code.

### CROSS-REFERENCE TO RELATED APPLICATIONS

This application claims the benefit of U.S. Provisional Application No. 62/267,473, filed on Dec. 15, 2015, which application is hereby incorporated herein by reference.

### TECHNICAL FIELD

The present invention relates generally to a system and method for real-time processing, and more specifically to a system and method for space and time aware organization and isolation of components (STOIC).

### BACKGROUND

Real-time systems, for example baseband processing systems, involve algorithmic kernels and data management kernels which are stitched together via extremely complex control code written in a generic language, for example C. The control code, which involves many complicated conditions, may be difficult to understand and update due to its complexity. The control code may include infrastructure for moving around data.

### SUMMARY

In accordance with an embodiment of the present invention, a method includes obtaining, by a first processor, a first software architecture description file and obtaining, by the first processor, a platform independent model file. The method also includes obtaining, by the first processor, a platform architecture definition file and performing, by the first processor, a first source-to-source compilation in accordance with the first software architecture description file, the platform independent model file, and the platform architecture definition file, to produce generated interface code. Additionally, the method includes generating, by the first processor, run time code, in accordance with the generated interface code and running, by a second processor in real time, the run time code.

In accordance with another embodiment of the present invention, a method includes obtaining, by a first processor, a file including software modules and performing, by the first processor, source-to-source compilation on the file to produce a generated kernel and data management file and a header file corresponding to the generated kernel and data management file. The method also includes generating, by the first processor, run time code, in accordance with the generated kernel and data management file, the header file, and a generated interface code and running, by a second processor, in real time, the run time code.

In accordance with an additional embodiment of the present invention, system includes a first non-transitory memory storage including instructions and one or more first processors in communication with the first memory. The one or more first processors execute the instructions to obtain a software architecture description file, obtain a platform independent model file, and obtain a platform architecture definition file. The instructions also include instructions to perform a first source-to-source compilation on the software architecture description file, the platform independent model file, and the platform architecture definition file, to produce generated interface code and generate run time code in accordance with the generated interface code. Additionally, the system includes a second non-transitory memory storage including instructions and one or more second processors in communication with the second memory, where the one or more second processors execute the instructions to run the run time code.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates an embodiment real time system architecture;

FIG. 2 illustrates an embodiment system with multiple temporal domains;

FIG. 3 illustrates another embodiment system with multiple temporal domains;

FIG. 4 illustrates an embodiment system with multiple services in the same temporal domain;

FIG. 5 illustrates another embodiment system with multiple services in the same temporal domain;

FIG. 6 illustrates an embodiment system with multiple services in multiple temporal domains;

FIG. 7 illustrates another embodiment system with multiple services in multiple domains;

FIG. 8 illustrates a flowchart for an embodiment method of performing space and time aware organization and isolation of components (STOIC);

FIG. 9 illustrates a flowchart for an embodiment method of implementing a system with multiple temporal domains;

FIG. 10 illustrates an embodiment block diagram of an embodiment processing system; and

FIG. 11 illustrates an embodiment block diagram of an embodiment transceiver.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

It should be understood at the outset that although an illustrative implementation of one or more embodiments are provided below, the disclosed systems and/or methods may be implemented using any number of techniques, whether currently known or not. The disclosure should in no way be limited to the illustrative implementations, drawings, and techniques illustrated below, including the exemplary designs and implementations illustrated and described herein, but may be modified within the scope of the appended claims along with their full scope of equivalents.

A real-time system (RTS) is a container which may contain multiple temporal domains having a variety of services, where a service is a collection of algorithmic pieces. In some embodiments, multiple temporal domains interact with each other under predefined temporal constraints, so the RTS as a whole can satisfy its real-time requirements. In one example, an RTS illustrates processing for wired communications, and in other examples may use wireless communications, or a combination of wired and wireless communications. The system may invoke a collection of services to perform a significant endeavor. For example, a channel estimation procedure is an example of a service. The channel estimation procedure may run on a digital signal processor (DSP), which is a highly specialized processor. To utilize vector units of the DSP, data is fed in a particular shape and size. A real time system may operate a variety of services operating in different temporal domain. A temporal domain is a portion of a system operating at the same temporal domain rate. It is desirable to provide interfaces between services operating in different temporal domains.

An embodiment RTS may be implemented with a variety of platforms and targets. Embodiments of the RTS provide a flexible framework for generating code and scheduling parameters to implement different services operating in different temporal domains. Thus, as technology changes, the system organization may be maintained while updating the hardware and specific implementation.

An embodiment RTS may be described by a domain specific language (DSL), and may use an automated framework to create the platform-specific lower level implementation. An embodiment methodology is defined, which corresponds to the DSL. An example of a DSL includes space and time aware organization and isolation of components (STOIC). In an embodiment, a framework is used for describing real-time systems as collections of temporal domains. In one embodiment, the real-time system is a baseband processing system. An embodiment system and method improves scalability by using the same framework for different implementations. In an embodiment, complex C-level control code is automatically generated through source-to-source compilation of a DSL to C, or to another source level language. A DSL infrastructure may include a language combined with a tool chain for the design of RTSs. The DSL describes temporal behaviors, constraints, and interactions which can be described and compiled into detailed, correct-by-construction hardware and software architecture in an automated fashion.

In an embodiment, system-level parallelism is exposed using STOIC constructs. Immutable constructs may be used by STOIC. An immutable value either has no value, for example it is explicitly unset, or takes on a single value for all time. Once an immutable value is set, there is no risk of using the wrong version of it, because it never changes. An immutable stream is either totally unset or it totally set for all time. The immutable stream becomes a semi-infinite immutable variable. In an embodiment, STOIC defines the relationship between elements in streams explicitly in a way that is more flexible than a static data flow.

In an embodiment, STOIC captures the rate of operation concept for individual modules. The combination of exposure of parallelism and the use of immutability facilitates compiler optimization techniques which may be applied to manually-written C code.

In an embodiment, the RTS includes a real-time data warehouse (rDW). An rDW involves efficient storage management for defining, accessing, and managing stored data. An embodiment rDW includes hardware, firmware, and software. Additionally, an rDW data definition (rDD) may be implemented using a programming language such as C/C++ and rDW query definitions (rQD) using a real-time query language (rQL), for example a structured query language (SQL). Additional details on real-time data warehouses are discussed in U.S. patent application Ser. No. 14/800,354 filed on Jul. 15, 2015, and entitled “System and Method for Data Warehouse and Fine Granularity Scheduling for System on Chip (SoC),” which application is hereby incorporated herein by reference. Further details on rDWs are discussed in U.S. patent application Ser. No. 15/169,094 filed on May 31, 2016, and entitled “System and Method for Real-Time Data Warehousing,” which application is hereby incorporated herein by reference.

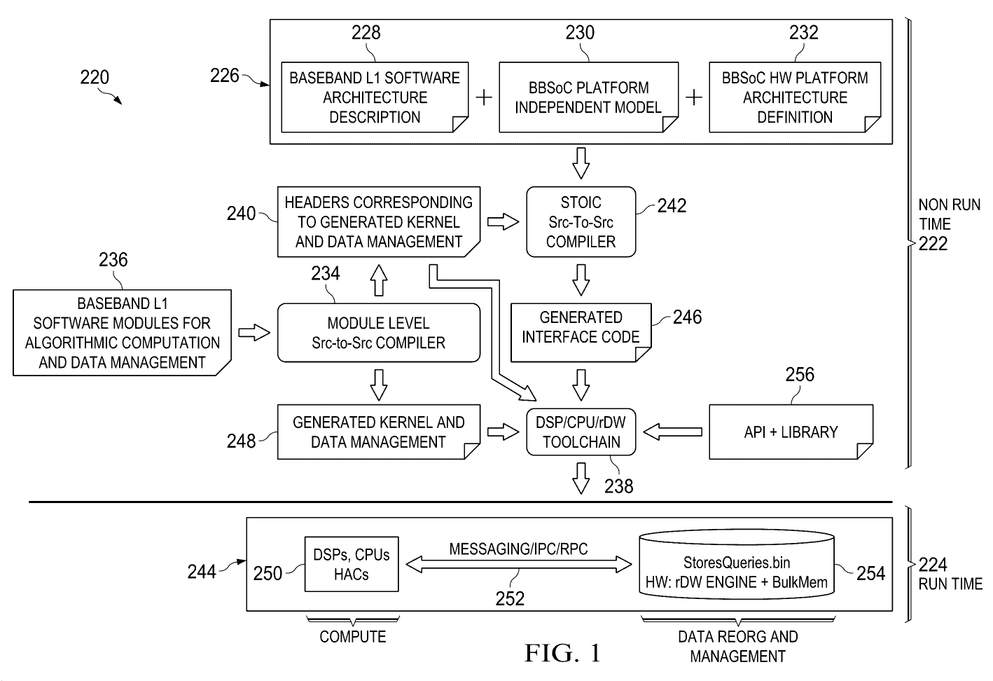

FIG. 1 illustrates the automated infrastructure 220 for generating and running code in a real-time system. The automated infrastructure 220 includes non-run time environment 222, where code is generated before runtime, and run time environment 224, where code is executed by one or more real time systems at run time.

Non-run time environment 222 includes the architecture description 226. The architecture description 226 includes information on the platform which for compilation of the code. The architecture description 226 contains the baseband level 1 (L1) software architecture description 228, the baseband system-on-a-chip (BBSoC) platform independent model 230, and the BBSoC HW platform architecture definition 232. The baseband L1 software architecture description 228 describes the connectivity among services, rate matching, the division of the system into temporal domains, and the connectivity to smart storage. A DSL, such as STOIC, may be used to describe the baseband L1 software architecture description 228. Also the BBSoC platform independent model 230 contains a platform independent abstraction of the hardware. Additionally, the BBSoC HW platform architecture definition 232 includes platform specific details of the hardware. The architecture description 226 is used by the STOIC source-to-source (Src-to-Src) compiler to generate interface code.

The non-run time environment 222 also includes the baseband L1 software modules for algorithmic computation and data management. In an embodiment, the baseband L1 software modules for algorithmic computation and data management use a DSL, such as CW and/or rQL. The module level Src-to-Src compiler 234 performs compilation on the baseband L1 software L1 modules for algorithmic computation and data management 236. The module level Src-to-Src compiler 234 generates headers corresponding to the generated kernel, and data management 240 and the generated kernel and data management 248. The headers corresponding to generated kernel and data management 240, for example .h files, provides the interfaces to modules and computational function calls. The generated kernel and data management 248 includes C and intrinsic code pieces.

The STOIC Src-to-Src compiler 242 performs source-to-source compilation on the architecture details 226 and the headers corresponding to generated kernel and data management 240. The STOIC Src-to-Src compiler 242 stitches the real time system together. Then, the STOIC Src-to-Src compiler 242 produces the generated interface code 246. The generated interface code 246 may be in C, or another programming language, for example another general purpose programming language.

In the non-run time system 222, the DSP/CPU/rDW toolchain 238 generates machine executable binary code for all aspects of the run time system 224. The DSP/CPU/rDW toolchain 238 generates code based on the generated interface code 246, the headers corresponding to generated kernel and data management 240, the generated kernel and data management 248, and application programming interface (API) and library 256, which includes predefined libraries and APIs. The generated code is then used in the run time environment 224 in real time.

Run time environment 224 includes the compute module 250 and the data reorganization and management 254, which communicate via messaging/inter-process communication (IPC)/remote procedure call (RPC) 252, in run time environment 244. The compute module 250 includes hardware, such as DSPs, CPUs, and HACs. The data reorganization and management module 254 is a distributed smart storage, and may include StoresQueries.bin, one or more binary files, hardware, such as a CPU and/or an rDW engine. The binary file is an executable file stored in memory, which may be run on the compute engine 250.

An embodiment RTS enables multiple temporal domains to be used to perform multiple services. In some embodiments, the RTS allows one or more than one smart storages to communicate using multiple temporal domains. In an additional embodiment, multiple temporal domains interact with each other under pre-defined temporal constraints, so the RTS as a whole can meet its real-time requirements. Also, an embodiment RTS uses a DSL infrastructure, where the DSL describes temporal behaviors, constraints, and interactions which are described and compiled into detailed, correct-by-construction hardware and software architecture in an automated manner. An embodiment DSL is STOIC, which may be used with a compiler. STOIC may contain definitions for temporal domains, services within temporal domains (including a representation of dataflows underlying the services), temporal relations between services and temporal domains, interfaces between services and temporal domains, hierarchical compositions of services within a temporal domain, and hierarchical compositions of temporal domains within the RTS.

In an embodiment, STOIC stitches together services written in different languages, such as rQL, CW/CM, C, support queries and updates, general purpose computation, and C-like data structures. Data structures more complicated than tables may be used. In an embodiment, STOIC is written in the style of a classical DSL, where a simple language makes calls to complex and domain specific functionality. Concurrency may be built in to STOIC, similar to hardware description languages or SystemC. In an embodiment, STOIC is compiled into C code for execution by a general purpose processor. In another embodiment, the STOIC code is compiled for use on an integrated special purpose processor. STOIC enables the RTS system to operate multiple services in multiple temporal domains. In an embodiment, the STOIC code is compiled into a hardware description language.

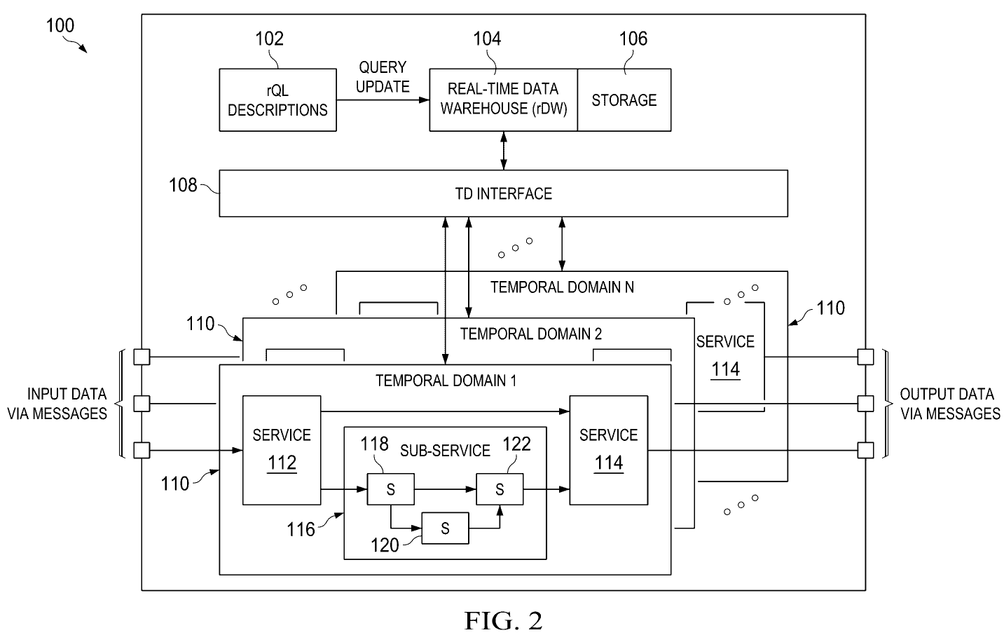

FIG. 2 illustrates the RTS 100 having multiple temporal domains 110. Each temporal domain 110 operates at a well-defined rate, and includes a set of services, or stateless processes. A service is a process that treats each request as an independent transaction unrelated to previous requests. Three temporal domains 110 are pictured, but any number of temporal domains 110 may be used. A temporal domain contains one or more than one service operating at a particular temporal domain rate. In a temporal domain, input data streams and output data streams operate at the temporal domain rate. A temporal domain 110 contains a sequence of jobs that trigger an integer multiple of a fundamental domain rate of that temporal domain 110. A temporal domain may contain multiple services, for example services 112, 114, and 116, and a service may contain multiple sub-services. For example, service 116 contains sub-services 118, 120, and 122. In one embodiment, temporal domains 110 are stateless. Alternatively, the temporal domains 110 are not stateless.

In an embodiment temporal domain 110, triggering occurs only once in a known period of time, inverse to the temporal domain rate. Triggering within this period may be a condition for correct operation of the service, but there may be some variability in the moment of triggering. In some embodiments, all inputs and outputs for all services in one temporal domain 110 also operate at an integer multiple of the temporal domain rate. When an RTS, such as the RTS 100, contains multiple temporal domains 110, different temporal domains 110 may use different temporal domain rates. The temporal domain rate indicates the speed or frequency that the domain operates at, but may be used to describe other factors that govern the rate in which a domain is operated. Rate relations between temporal domain rates of different temporal domains 110 are the multiplicative factor between the temporal domain rates of two temporal domains 110. Two temporal domains 110 are integer rate related when their rates are related by an integer multiplicative factor. In an embodiment, two integer rate related temporal domains 110 have a member of relationship. In a member of relationship, every service in one temporal domain is also a member of another temporal domain. Alternatively, two integer rate related temporal domains 110 do not have a member of relationship. All temporal domains 110 in the RTS 100 are rate related, but not necessarily integer rate related. In some embodiments, the number of temporal domains 110 not integer related to other temporal domains 110 is limited to accommodate asynchronous inputs and timers.

Two temporal domains 110 communicate through a temporal domain (TD) interface 108 when services in one temporal domain no receive inputs from and/or send outputs to services in the other temporal domain no. The inputs and outputs to and from temporal domains 110 may be streams of data, or semi-static data, including aperiodic data, which may be implemented via messaging. The TD interface 108 coordinates interactions between the temporal domains 110 and with the rDW 104. The temporal domains 110 operate in parallel. Also, the TD interface 108 controls the rate one or more services operate.

The temporal domains 110 receive input data and transmit output data via immutable streams of collections independently of the TD interface 108. In an embodiment, the services 112, 114, and 116 are event driven, and some of the input data and output data are dealt with similarly to infinite streams being transmitted at the same data rate for a given service. The TD interface 108 provides unified data flow and control. Additionally, the TD interface 108 may be implemented in hardware, software, or a combination of hardware and software. In one embodiment, shared memory is present in the TD interface 108.

In the depicted embodiment, the RTS 100 uses one rDW 104 for data management. In other embodiments, the RTS 100 does not use an rDW, and may use another external storage. In an additional embodiment, the RTS 100 contains multiple rDWs 104. The rDW 104 contains the storage 106. Additionally, the rDW 104 receives query updates from the rQL descriptions 102. In an embodiment, the services do not contain storage, and data is stored in the rDW 104. Alternatively, at least some services contain storage.

In an embodiment RTS, multiple services operate in independent temporal domains, which enhances optimizations of the services in the RTS system. At a high level, a service may be a long term evolution (LTE) channel or a universal mobile telecommunications system (UMTS) channel. At a middle level, a service may perform channel estimation, which can support higher level services. More specifically, a service may provide distinct functionality to the real-time system, for example multiple-input multiple-output (MIMO) processing. Some additional examples of services in long term evolution (LTE) include physical channel processing, such as a physical downlink control channel (PDCCH) processing or physical uplink shared channel (PUSCH) processing, demodulation reference signal (DMRS) processing, or sounding reference signal (SRS) processing. Parts of a service may also be a service. For example, channel estimation or processing on particular reference symbols may be services, which may also be a part of a PUSCH service. The demarcation of services may be based on the organization of an RTS. Higher level services, such as channels, are composed of algorithmic services. The services may include multiple services dynamically instantiated at the same time, support for parameterization of the services, services driven by quality of service (QoS) requirements from outside the system, support for hierarchy, services which include other services, and support for description of dependencies between services.

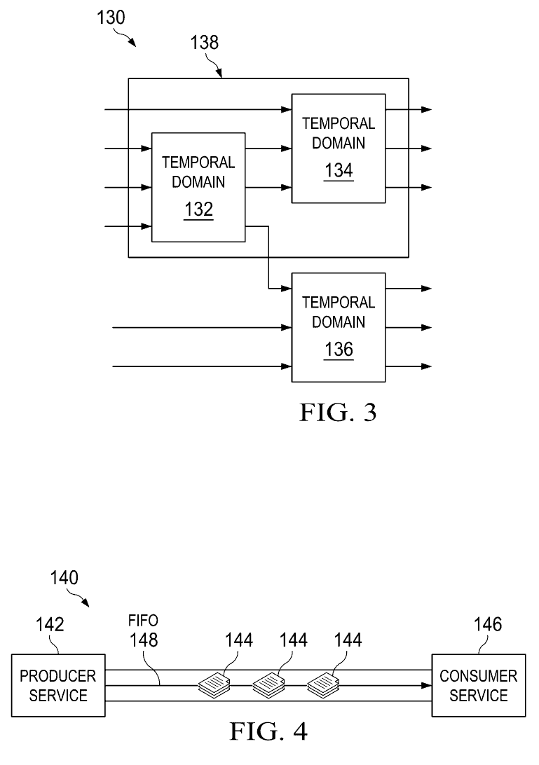

FIG. 3 illustrates the RTS 130, which depicts multiple temporal domains, including hierarchically nested temporal domains. The temporal domain 138 contains the temporal domain 132 and the temporal domain 134. In one embodiment, the temporal domain 132 creates a stream, which produces data at the rate of that temporal domain. When this stream crosses into the temporal domain 134, the rate of the stream is rate matched by a rate converter to match the rate of the temporal domain 134. When an output stream produced by the temporal domain 132 enters the temporal domain 136, the stream is rate matched twice. First, the stream is rate matched as it transitions from the temporal domain 132 to the temporal domain 138. Then, the stream rate matches output stream's rate to match the rate of temporal domain 136 from the temporal domain 138. The RTS 130 defines rules for construction, and the compiler may know how to determine a need for rate matching when streams cross temporal domains.

The temporal domain 132 is a member of the temporal domain 134 when all services in the temporal domain 134 are also in the temporal domain 132, but not all services of the temporal domain 132 are in the temporal domain 134.

Services may adhere to constraints of real-time systems, such as resource requirements for dataflow components and/or services. The resource requirements may include which dependencies are needed for instantiation. In an embodiment, the resource requirements include whether a QoS requirement is from a northbound interface, and the northbound interface is used to communicate with a higher level protocol stack. In a wireless environment, for example a wireless environment using OpenStack, two channels may be instantiated, and the configuration manager is notified of the QoS requirements for the channels.

Various tools may be used to execute an RTS. These tools include both source-to-source and source-to-binary tools. In an embodiment, a STOIC code compilation yields inputs, configuration, or a table for a workload assignment engine which partitions the workload onto processors or clusters of processors. A STOIC compiler, given platform characteristics of a particular target platform, generates data shaping requirements, which must be met for the compiled STOIC code to perform efficiently. In an embodiment, a STOIC system includes an rQL compiler, or another compiler. In an embodiment, the STOIC language interfaces with a workload assignment engine, and may have an awareness of concepts such as near and far, to facilitate interfacing with the workload assignment engine. Additionally, STOIC may define run time requirements that the language represents and conveys to the slow scheduler, without having to tell the scheduler which job to place in which queue.

The STOIC language may describe system-on-a-chip (SoC) or other level dataflow, for example via interfaces which are strictly periodic, and where data follows a first-in-first-out (FIFO) order. The STOIC language may define parameters, timing constraints, and resource requirements applying to nodes and/or edges in the dataflow, for example via interfaces with an undefined periodicity, and where data is in a semi-static order. Additionally, the STOIC language defines the composition of services in a hierarchical composition and directives from the SoC-level regarding scheduling and mapping to processor cores.

An embodiment RTS is aware of data conversion rules when inputs or outputs cross from one temporal domain to another, to prevent stochastic back-up of data, for example by performing data padding or decimation. The data conversion rules may be specified using STOIC or another language. These rules may be extended in syntax and semantics, because the interface is logical, or by another DSL. In an embodiment, a different DSL is compiled into STOIC and other language pieces. The compiler uses the data conversion definitions to create control code to perform padding, decimation, or other functions, such as other data conversion functions. The definitions may include a defining interface between two temporal domains that are not integer related.

The properties of the inputs and outputs of the temporal domains or services are characterized by data ordering properties and usage properties. When executing the STOIC language, there may be different ordering options for collections of data, such as FIFO order and semi-static order. In FIFO order, each collection of data is received or sent only once. In semi-static order, each collection data remains intact and useable until the next collection of data is received, and when the next collection of data is received, this collection of data overwrites the previous collection of data.

The arrival of input or output data is either periodic or non-periodic. For a periodic rate, the input or output is integer rate related to the temporal domain rate of the temporal domain. On the other hand, for a non-periodic rate, the input or output may be generated with arbitrary gaps between consecutive generation events. For a non-periodic rate, a subsequent stage scheduler may react to the actual rate at which n pieces of data come out. In an embodiment, the data is tagged with metadata for data that is loosely periodic, and STOIC and the associated tool chain capture and generate as an output the metadata and the dataflows. In one embodiment, the rate is non-periodic, but has ordering metadata. This embodiment is non-periodic, but resembles a periodic rate. The compiler may determine characteristics about the pattern of valid data within a stream based on the metadata. In an embodiment, a probability or probability distribution is used to check the validity of a data stream. This information may then be used by the compiler to decide a mechanism to put into place to check whether arriving data in an actual system is valid.

The inputs and outputs of temporal domains and services may be implemented in a variety of manners. In one embodiment, the input of the temporal domain is a stream in FIFO order with a strictly periodic rate. In another embodiment, the input of a temporal domain is sporadic with an undefined rate. In both of these embodiments, metadata may be used to modify the relationship of the temporal domain for compatibility. There may be a state in the temporal domain where data passing between services within the temporal domain is delayed or stored for a finite amount of time. In this example, the temporal domain is not stateless. Delays may be stored and released in FIFO order, so the insertion of the delay does not change the temporal domain.

In an embodiment, a STOIC system fulfills requirements of an RTS system. The STOIC system may be aware of cost in time and priority of a request by a processing system for configuring temporal domains. In an embodiment, the STOIC system may prioritize services to fulfill the tasks in different temporal domains, optimizing the resources available.

FIGS. 4-7 illustrate examples of real-time systems, for example to further expand on real-time systems illustrated in FIG. 2 and FIG. 3. In an example, these real-time systems may be developed using the system illustrated in FIG. 1.

FIG. 4 illustrates the RTS 140, which has a single temporal domain, in which the producer service 142 and the consumer service 146 are in the same temporal domain. In one embodiment, the producer service 142 is a Fast Fourier Transform (FFT) service and the consumer service 146 is a gain control service. The collections of data 144 proceed along the data stream 148 from the producer service 142 to the consumer service 146 in first-in first-out (FIFO) order where each entry in the stream is an unordered collection of data. At each tick of the temporal domain, the producer service 142 inserts one unordered collection of data 144, or data objects, at the tail of the data stream 148, and the consumer service 146 consumes one collection of data 144 from the head of the data stream 148. The producer service 142 produces collections of data 144, and the consumer service 146 consumes collections of data 144. A collection of data 144 is treated as a single entity, and FIFO order is maintained in the data stream 148. Data stream properties determine the details of how the collection of data 144 in the data stream 148 is presented at the head of the data stream 148 after each tick. In one embodiment, the new collection of data 144 inserted by the producer service 142 replaces the collection of data 144 presented by the data stream 148 at the head of the data stream 148. In this embodiment, the data stream 148 corresponds to a synchronous dataflow.

FIG. 5 illustrates the RTS 150, which includes the producer service 152, the producer service 160, and the consumer service 158 in a single temporal domain. The RTS 150 may be used for synchronous dataflows and more general dataflows which cannot be represented as synchronous dataflows. In one embodiment, the producer service 152 is a channel estimation service, the producer service 160 is a user information service, and the consumer service 158 is a MIMO channel correlation calculation service. The data stream 162, which includes a collection of data in FIFO order, runs from the producer service 152 to the modulator 154. Additionally, the data stream 166, for example user information in FIFO order, from the producer service 160, modulates the data stream 162 at the modulator 154 to produce the data stream 164, which include the collections of data 156. The modulator 154 performs stream modulation, which generates a new view of each input collection of data from the producer service 152, guided by the modulation input from the producer service 160. The collections of data 156 arrive at the consumer service 158. At each tick of the temporal domain, the producer services 152 and 160 insert one collection of data at the tail of the data streams 162 and 166, respectively, and the consumer service 158 consumes one collection of data 156 at the head of the data stream 164 in FIFO order.

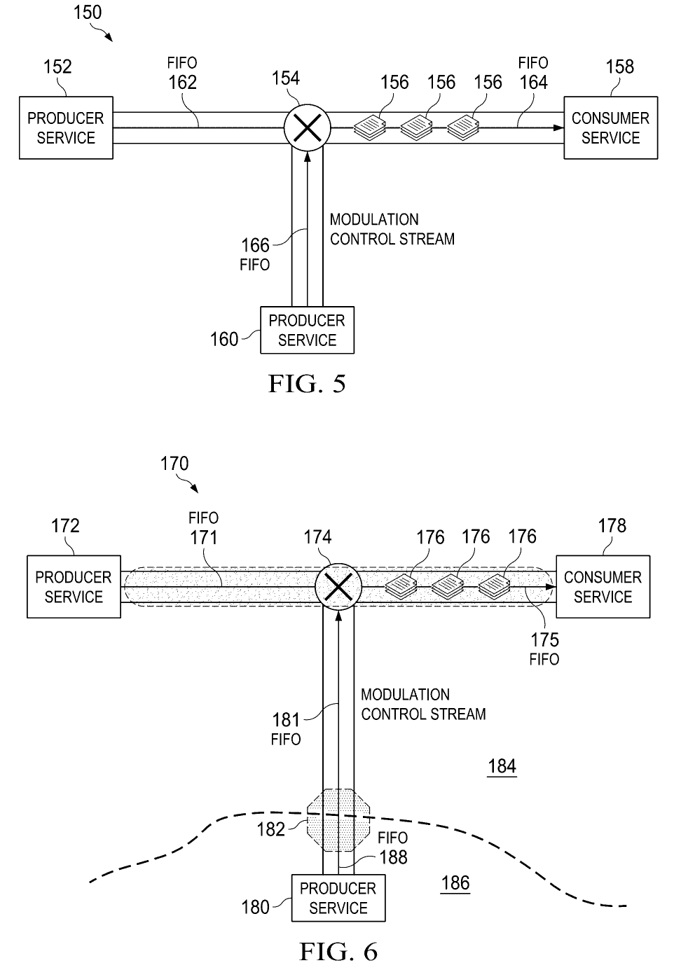

FIG. 6 illustrates the RTS 170 with the producer service 172 and the consumer service 178 in the temporal domain 184, and the producer service 180 in the temporal domain 186. In one embodiment, the producer service 172 is a demodulation reference signal (DMRS) digital automatic gain control (DAGC) service, the producer service 180 is a user information service, and the consumer service 178 is a channel estimation service. The data streams 171 and 175 stay in the temporal domain 184, and rate matching is not used. In one example, the temporal domain 184 ticks every 500 microseconds, for example aligned to every DMRS symbol in a 1 ms LTE subframe. In this example, the temporal domain 186 ticks every 1000 microseconds, for example aligned to every symbol ∘ in a 1 ms LTE subframe. The data stream 188 crosses from the temporal domain 186 to the temporal domain 184 at the stream crossing 182, to produce the data stream 181. The stream crossing 182 implies rate matching, in other words that the stream crossing 182 is a rate matcher, from the rate of the temporal domain 186 to the rate of the temporal domain 184. In one example, rate matching is statically configured, for example using zero insertion, replication, interpolation, decimation, or creation of a larger collection. Alternatively, the rate matching is a user-defined function. The data stream 181 acts as a modulation control stream, in FIFO order, for the data stream 171 at the modulator 174. The collections of data 176 of the data stream 175 are then received at the consumer service 178. In one embodiment, the view of the collections of data 176 at the consumer service 178 includes a subset of the DMRS DACG symbol only for users whose information is provided by the producer service 180.

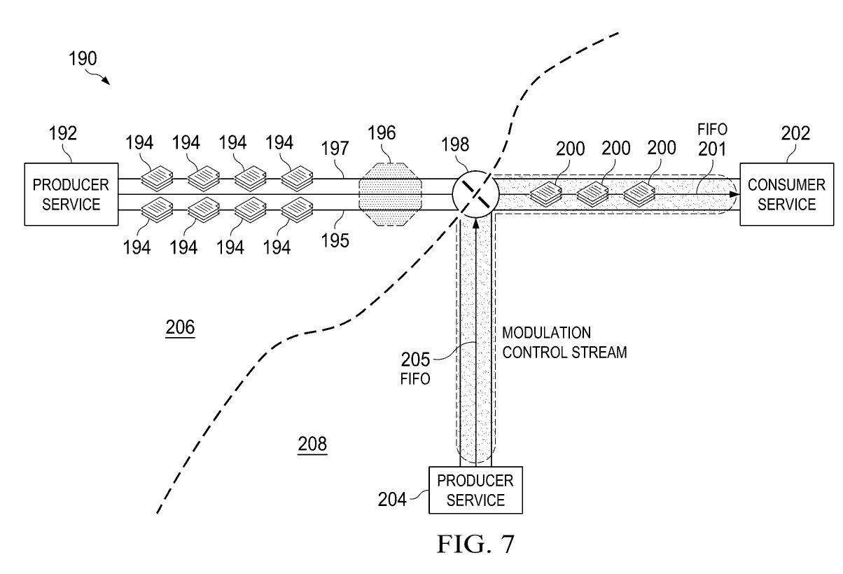

FIG. 7 illustrates the RTS 190, where the producer service 192 is in the temporal domain 206, and both the producer service 204 and the consumer service 202 are in the temporal domain 208. In one embodiment, the producer service 192 is an SRS processing and single-user beamforming weight calculation service for all users, the producer service 204 is a selected downlink (DL) user information service, and the consumer service 202 is a multi-user beamforming weight calculation service for selected DL users. In this embodiment, the temporal domain 206 ticks every n milliseconds, where n∈[2 . . . 320], for a 1 ms LTE subframe aligned to the fourteenth symbol of the subframe, and the temporal domain 208 ticks every 1000 microseconds for a 1 ms LTE subframe aligned to symbol ∘ of the subframe. The collections of data 194 of the data stream 195 are rate converted by the rate matcher 196 into the rate for temporal domain 208, to produce the data stream 197. The rate matcher 196 may be a user-defined function, or may be statically configured, for example zero insertion, replication, interpolation, decimation, or creation of a larger collection. The stream modulator 198 performs modulation on the data stream 197 as determined by data from the producer service 204. Rate matching is not performed on the FIFO data in the data stream 205, since the data stream 205 is already rate matched to the rate of temporal domain 208. The collections of data 200 of the data stream 201 are then received by the consumer service 202.

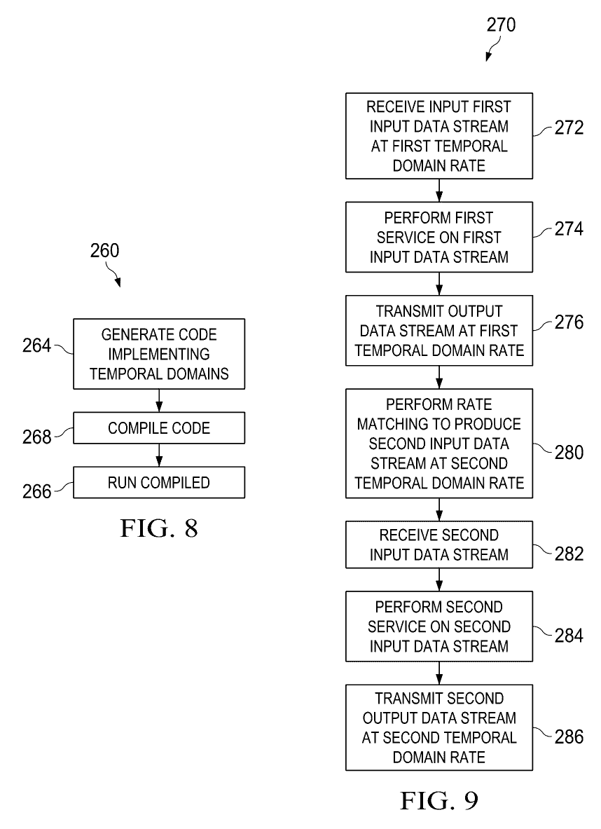

FIG. 8 illustrates a flowchart of an embodiment method 260 for STOIC in an RTS. In the block 264, a processor generates code to implement temporal domains. A processor organizes temporal domains, which may have different rates. In one embodiment, the temporal domains are implemented in parallel. In another embodiment, the temporal domains are in series, and services in different temporal domains interact with each other, for example using rate conversion. One temporal domain may contain multiple services, and a service may contain multiple sub-services. In one embodiment, one temporal domain is integer rate related to another temporal domain. In another embodiment, one temporal domain is a member of the other temporal domain. The data definitions illustrated in FIG. 1 may be used to configure the temporal domains. In an embodiment, interface code segments may be generated for various algorithmic computation and data management code segments. The code segments for different services may be generated separately, for example using different programming languages. The code may be generated by a DSL compiler, for example STOIC compiler. The DSL may include definitions for the temporal domains and the services. C level code may be automatically generated. Code in different programming languages may be generated to implement different services in a single RTS.

In the block 268, the processor compiles the code generated in block 264. The code may be source-to-source compiled. In one embodiment, compiling the code is performed by an rQL compiler. In another embodiment, compiling the code produces a configuration for a workload assignment engine. The compiler determines whether rate matching is needed at interfaces between temporal domains, and generates the rate matchers as needed. In one embodiment, the compiler compiles two functions in two different temporal domains as two separate functions with an asynchronous, reactive interface (i.e. a function call or something similar). In another embodiment, the compiler combines two functions into one larger function, because the relationship between the temporal domains is known. A stream in the STOIC DSL input to the compiler does not necessarily appear explicitly in the output of the compiler. In an embodiment, the compiler decides the mechanism by which two functions within different temporal domains communicate based on the metadata about the patterns within the streams.

In the block 266, the processor runs the compiled code generated in block 264. The instructions are executed in the temporal domains. Multiple services may be implemented on different temporal domains. In one embodiment, data from one data stream modulates data from another data stream. In one embodiment, the services are stateless, and the data is stored externally, for example using an rDW. In another example, at least some of the services have local storage. A service receives an input data stream, and performs the service to produce an output data stream. The data streams have the fundamental data rate of the temporal domain in which the service resides. There may be rate conversions between data streams when moving across different temporal domains having different temporal domain rates.

FIG. 9 illustrates a flowchart for the embodiment method 270 of implementing a system with multiple temporal domains. The blocks in method 270 are illustrated in sequence for clarity, but the various operations may be performed in parallel. The method 270 illustrates the interactions between two services in two temporal domains, but many more services may interact in other embodiments. For example, services in three, four, five, or more temporal domains may interact.

In block 272, a first input data stream is received at a first rate in a first temporal domain. In one embodiment, the input data stream is periodic. In another embodiment, the input data stream is non-periodic, and is converted to a periodic data stream via a suitable rate matcher. In block 274, a first service is performed on the first input data stream received in block 272. The first service may be an FFT service, a channel estimation service, a user information service, a DMRS DAGC service, an SRS service, or another service, such as another baseband processing service. In one example, the first service is stateless, and it may use external storage, such as an rDW. Alternatively, the first service contains local storage. The first service may be triggered once per a first period, where the first period is the inverse of the first data rate. Then, in block 276, the system transmits, as an output of the first service, an output data stream at the first temporal domain rate. The output data stream may be in FIFO order. In one embodiment, the output stream is converted to a semi-static order by the rate matcher.

In block 280, rate matching is performed on the output data stream. The output data stream is converted to a second input data stream having a second rate of a second temporal domain using rate matching. In one embodiment, rate matching is statically configured, for example using zero insertion, replication, interpolation, decimation, or creation of a larger collection. Alternatively, the rate matching is a user-defined function.

The second input data stream produced in block 280 is received in block 282 in the second temporal domain. Next, in block 284, a second service is performed on the second input data stream. The second service may be a channel estimation service, a MIMO channel correlation calculation service, a multi-user beamforming weight calculation service, a gain control service, or another service, such as another baseband service. The second service performed in block 284 is performed in parallel with the first service performed in block 274. In one embodiment, the second service is stateless, and uses external storage, for example an rDW. Alternatively, the second service contains local storage. The second service may be triggered once per a second period, where the second period is the inverse of the second temporal domain rate. Then, the second service transmits a second output data stream at the second temporal domain rate in block 286.

In an embodiment, arbitration may be performed between the first service and the second service.

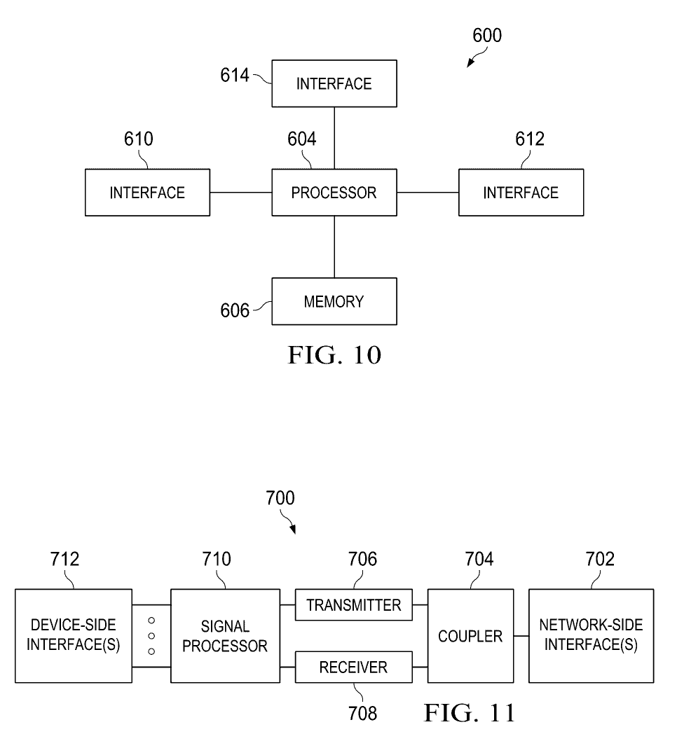

FIG. 10 illustrates a block diagram of an embodiment processing system 600 for performing methods described herein, which may be installed in a host device. As shown, the processing system 600 includes a processor 604, a memory 606, and interfaces 610-614, which may (or may not) be arranged as shown in FIG. 10. The processor 604 may be any component or collection of components adapted to perform computations and/or other processing related tasks, and the memory 606 may be any component or collection of components adapted to store programming and/or instructions for execution by the processor 604. In an embodiment, the memory 606 includes a non-transitory computer readable medium. The interfaces 610, 612, 614 may be any component or collection of components that allow the processing system 600 to communicate with other devices/components and/or a user. For example, one or more of the interfaces 610, 612, 614 may be adapted to communicate data, control, or management messages from the processor 604 to applications installed on the host device and/or a remote device. As another example, one or more of the interfaces 610, 612, 614 may be adapted to allow a user or user device (e.g., personal computer (PC), etc.) to interact/communicate with the processing system 600. The processing system 600 may include additional components not depicted in FIG. 10, such as long term storage (e.g., non-volatile memory, etc.).

In some embodiments, the processing system 600 is included in a network device that is accessing, or part otherwise of, a telecommunications network. In one example, the processing system 600 is in a network-side device in a wireless or wireline telecommunications network, such as a base station, a relay station, a scheduler, a controller, a gateway, a router, an application server, or any other device in the telecommunications network. In other embodiments, the processing system 600 is in a user-side device accessing a wireless or wireline telecommunications network, such as a mobile station, a user equipment (UE), a personal computer (PC), a tablet, a wearable communications device (e.g., a smartwatch, etc.), or any other device adapted to access a telecommunications network.

In some embodiments, one or more of the interfaces 610, 612, 614 connects the processing system 600 to a transceiver adapted to send and receive signaling over the telecommunications network. FIG. 11 illustrates a block diagram of a transceiver 700 adapted to send and receive signaling over a telecommunications network. The transceiver 700 may be installed in a host device. As shown, the transceiver 700 comprises a network-side interface 702, a coupler 704, a transmitter 706, a receiver 708, a signal processor 710, and a device-side interface 712. The network-side interface 702 may include any component or collection of components adapted to transmit or receive signaling over a wireless or wireline telecommunications network. The coupler 704 may include any component or collection of components adapted to facilitate bi-directional communication over the network-side interface 702. The transmitter 706 may include any component or collection of components (e.g., up-converter, power amplifier, etc.) adapted to convert a baseband signal into a modulated carrier signal suitable for transmission over the network-side interface 702. The receiver 708 may include any component or collection of components (e.g., down-converter, low noise amplifier, etc.) adapted to convert a carrier signal received over the network-side interface 702 into a baseband signal. The signal processor 710 may include any component or collection of components adapted to convert a baseband signal into a data signal suitable for communication over the device-side interface(s) 712, or vice-versa. The device-side interface(s) 712 may include any component or collection of components adapted to communicate data-signals between the signal processor 710 and components within the host device (e.g., the processing system 600, local area network (LAN) ports, etc.).

The transceiver 700 may transmit and receive signaling over any type of communications medium. In some embodiments, the transceiver 700 transmits and receives signaling over a wireless medium. For example, the transceiver 700 may be a wireless transceiver adapted to communicate in accordance with a wireless telecommunications protocol, such as a cellular protocol (e.g., long-term evolution (LTE), etc.), a wireless local area network (WLAN) protocol (e.g., Wi-Fi, etc.), or any other type of wireless protocol (e.g., Bluetooth, near field communication (NFC), etc.). In such embodiments, the network-side interface 702 comprises one or more antenna/radiating elements. For example, the network-side interface 702 may include a single antenna, multiple separate antennas, or a multi-antenna array configured for multi-layer communication, e.g., single input multiple output (SIMO), multiple input single output (MISO), multiple input multiple output (MIMO), etc. In other embodiments, the transceiver 700 transmits and receives signaling over a wireline medium, e.g., twisted-pair cable, coaxial cable, optical fiber, etc. Specific processing systems and/or transceivers may utilize all of the components shown, or only a subset of the components, and levels of integration may vary from device to device.

One embodiment includes a plurality of modules for performing the disclosed methods and processing. Specifically, the method includes a means for obtaining a file comprising software modules and a means for performing source-to-source compilation on the file to produce a generated kernel and data management file and a header file corresponding to the generated kernel and data management file. The embodiment further includes a means for generating run time code, in accordance with the generated kernel and data management file, the header file, and a generated interface code and a means for running the run time code in real time.

In one embodiment, the means for obtaining is configured to obtain an application program interface (API), wherein the means for generating the run time code generates the run time code in accordance with the API. Furthermore, the means for performing source-to-source compilation is configured to use a domain specific language (DSL) in one embodiment.

Additional embodiments of the invention may be described in relation to the clauses listed below.

Clause 1. A method comprising:

obtaining, by a first processor, a first software architecture description file;

obtaining, by the first processor, a platform independent model file;

obtaining, by the first processor, a platform architecture definition file;

performing, by the first processor, a first source-to-source compilation in accordance with the first software architecture description file, the platform independent model file, and the platform architecture definition file, to produce generated interface code;

generating, by the first processor, run time code, in accordance with the generated interface code; and

running, by a second processor in real time, the run time code.

Clause 2. The method of clause 1, further comprising obtaining, by the first processor, a second software architecture description file, wherein performing the first source-to-source compilation is performed in accordance with the second software architecture description file, wherein the first software architecture description file comprises a first temporal domain, and wherein the second software architecture description file comprises a second temporal domain.

Clause 3. The method of any one of clauses 1-2, wherein the first temporal domain has a first temporal domain rate and the second temporal domain has a second temporal domain rate, wherein the first temporal domain rate is different than the second temporal domain rate.

Clause 4. The method any one of clauses 1-3, wherein the first temporal domain comprises a first service and the second temporal domain comprises a second service.

Clause 5. The method of any one of clauses 1-4, wherein performing the first source-to-source compilation comprises combining the first service and the second service into a third service in the generated interface code.

Clause 6. The method of any one of clauses 1-5, wherein running the run time code comprises:

receiving, by the first service, a first input data stream at the first temporal domain rate, in real-time;

performing the first service on the first input data stream to produce a first output data stream;

transmitting, by the first service the first output data stream;

performing rate matching on the first output data stream to produce a second input data stream, wherein the second input data stream has the second temporal domain rate; and

receiving, by the second service, the second input data stream.

Clause 7. The method of any one of clauses 1-6, further comprising adding metadata to the first input data stream.

Clause 8. The method of any one of clauses 1-7, wherein the first software architecture description file further comprises rate matching between the first temporal domain rate of the first temporal domain and the second temporal domain rate of the second temporal domain.

Clause 9. The method of any one of clauses 1-8, wherein the first software architecture description file is in a first programming language and the second software architecture description file is in a second programming language.

Clause 10. The method of any one of clauses 1-9, wherein the first temporal domain is a member of the second temporal domain.

Clause 11. The method of any one of clauses 1-10, wherein performing the first source-to-source compilation comprises determining characteristics of a pattern of valid data for a first input stream of the first temporal domain.

Clause 12. The method of any one of clauses 1-11, further comprising:

obtaining, by the first processor, a file comprising software modules; and

performing, by the first processor, a second source-to-source compilation on the file to produce a generated kernel and data management file and a header file corresponding to the generated kernel and data management file, wherein performing the first source-to-source compilation is performed in accordance with the header file.

Clause 13. The method of any one of clauses 1-12, wherein running the generated interface code further comprises performing messaging, by the second processor, with bulk memory.

Clause 14. The method of any one of clauses 1-13, wherein the platform independent model file is for a baseband system-on-a-chip (BBSoC).

Clause 15. The method of any one of clauses 1-14, wherein the first source-to-source compiler is a domain specific language (DSL) compiler.

Clause 16. The method of any one of clauses 1-15, wherein the generated interface code is in a general purpose programming language.

Clause 17. A method comprising:

obtaining, by a first processor, a file comprising software modules;

performing, by the first processor, source-to-source compilation on the file to produce a generated kernel and data management file and a header file corresponding to the generated kernel and data management file;

generating, by the first processor, run time code, in accordance with the generated kernel and data management file, the header file, and a generated interface code; and

running, by a second processor, in real time, the run time code.

Clause 18. The method of clause 17, further comprising obtaining, by the first processor, an application program interface (API), wherein generating the run time code is further performed in accordance with the API.

Clause 19. The method of any one of clauses 17-18, wherein performing source-to-source compilation is performed using a domain specific language (DSL).

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method comprising:
obtaining, by a first processor, a first software architecture description file;
obtaining, by the first processor, a platform independent model file;
obtaining, by the first processor, a platform architecture definition file;
performing, by the first processor, a first source-to-source compilation in accordance with the first software architecture description file, the platform independent model file, and the platform architecture definition file, to produce generated interface code;
generating, by the first processor, run time code, in accordance with the generated interface code; and
running, by a second processor in real time, the run time code.

2. The method of claim 1, further comprising obtaining, by the first processor, a second software architecture description file, wherein performing the first source-to-source compilation is performed in accordance with the second software architecture description file, wherein the first software architecture description file comprises a first temporal domain, and wherein the second software architecture description file comprises a second temporal domain.

3. The method of claim 2, wherein the first temporal domain has a first temporal domain rate and the second temporal domain has a second temporal domain rate, wherein the first temporal domain rate is different than the second temporal domain rate.

4. The method of claim 3, wherein the first temporal domain comprises a first service and the second temporal domain comprises a second service.

5. The method of claim 4, wherein performing the first source-to-source compilation comprises combining the first service and the second service into a third service in the generated interface code.

6. The method of claim 4, wherein running the run time code comprises:
receiving, by the first service, a first input data stream at the first temporal domain rate, in real-time;
performing the first service on the first input data stream to produce a first output data stream;
transmitting, by the first service the first output data stream;
performing rate matching on the first output data stream to produce a second input data stream, wherein the second input data stream has the second temporal domain rate; and
receiving, by the second service, the second input data stream.

7. The method of claim 6, further comprising adding metadata to the first input data stream.

8. The method of claim 3, wherein the first software architecture description file further comprises rate matching between the first temporal domain rate of the first temporal domain and the second temporal domain rate of the second temporal domain.

9. The method of claim 2, wherein the first software architecture description file is in a first programming language and the second software architecture description file is in a second programming language.

10. The method of claim 2, wherein the first temporal domain is a member of the second temporal domain.

11. The method of claim 2, wherein performing the first source-to-source compilation comprises determining characteristics of a pattern of valid data for a first input stream of the first temporal domain.

12. The method of claim 1, further comprising:
obtaining, by the first processor, a file comprising software modules; and
performing, by the first processor, a second source-to-source compilation on the file to produce a generated kernel and data management file and a header file corresponding to the generated kernel and data management file, wherein performing the first source-to-source compilation is performed in accordance with the header file.

13. The method of claim 1, wherein running the generated interface code further comprises performing messaging, by the second processor, with bulk memory.

14. The method of claim 1, wherein the platform independent model file is for a baseband system-on-a-chip (BBSoC).

15. The method of claim 1, wherein the first source-to-source compiler is a domain specific language (DSL) compiler.

16. The method of claim 1, wherein the generated interface code is in a general purpose programming language.

17. A method comprising:
obtaining, by a first processor, a file comprising software modules;
performing, by the first processor, source-to-source compilation on the file to produce a generated kernel and data management file and a header file corresponding to the generated kernel and data management file;
generating, by the first processor, run time code, in accordance with the generated kernel and data management file, the header file, and a generated interface code; and
running, by a second processor, in real time, the run time code.

18. The method of claim 17, further comprising obtaining, by the first processor, an application program interface (API), wherein generating the run time code is further performed in accordance with the API.

19. The method of claim 17, wherein performing source-to-source compilation is performed using a domain specific language (DSL).

20. A system comprising:
a first non-transitory memory storage comprising instructions;
one or more first processors in communication with the first memory, wherein the one or more first processors execute the instructions to:
obtain a software architecture description file;
obtain a platform independent model file;
obtain a platform architecture definition file;
perform a first source-to-source compilation on the software architecture description file, the platform independent model file, and the platform architecture definition file, to produce generated interface code; and
generate run time code in accordance with the generated interface code;
a second non-transitory memory storage comprising instructions; and
one or more second processors in communication with the second memory, wherein the one or more second processors execute the instructions to run the run time code.
